(19) United States
(12) Patent Application Publication
(10) Pub. No.: US 2024/0142335 A1
(43) Pub. Date: May 2, 2024

(54) GAS LEAK DETECTOR AND DETECTION METHODS

(71) Applicant: OnPoint Technologies, LLC, Wichita, KS (US)

(72) Inventors: Bernard P. Masterson, Louisville, CO (US); Andrew D. Sappey, Lakewood, CO (US)

(21) Appl. No.: 18/278,634

(22) PCT Filed: Mar. 8, 2022
(86) PCT No.: PCT/US2022/019330

§ 371 Date: Aug. 24, 2023

Related U.S. Application Data
(60) Provisional application No. 63/157,897, filed on Mar. 8, 2021.

(51) Int. Cl. G01M 3/38; G01N 21/3504

(52) U.S. Cl. CPC G01M 3/38; G01N 21/3504; G01N 2021/3531; G01N 2201/06113

(57) ABSTRACT

A gas leak detector includes a solar detector and a signal filter. The solar detector generates an electrical response by interfering a light signal with a solar signal and detecting a resultant interference signal. The signal filter is communicatively coupled to the solar detector and filters the electrical response to isolate a beat-note signal. The beat-note signal has an amplitude that is inversely related to a concentration of a species that forms a gaseous plume located along a path of the solar signal.

### CROSS-REFERENCE TO RELATED APPLICATIONS

This application claims the benefit of U.S. Provisional Application No. 63/157,897, filed Mar. 8, 2021, which is incorporated herein by reference in its entirety.

### BACKGROUND

Methane gas is a potent green-house gas due to its strong absorption of infrared (IR) light. Methane gas in the earth's atmosphere serves to absorb sunlight on its way to the earth's surface and light emitted from the earth's surface, e.g., reflected, and emitted blackbody radiation. Methane is a more potent greenhouse gas than carbon dioxide due to its larger absorption of IR light. A main process by which methane is introduced into the atmosphere is by leaks. Methane storage and manufacturing facilities unintentionally release methane gas due to system failures and poor oversight. Detection of methane leaks is crucial to mitigating its unintended release into the environment.

### SUMMARY OF EMBODIMENTS

In a first aspect, a gas leak detector includes a solar detector and a signal filter. The solar detector generates an electrical response by interfering a light signal with a solar signal and detecting a resultant interference signal. The signal filter is communicatively coupled to the solar detector and filters the electrical response to isolate a beat-note signal. The beat-note signal has an amplitude that is inversely related to a concentration of a species that forms a gaseous plume located along a path of the solar signal.

In a second aspect, a method for detecting a gas leak includes detecting an interference signal produced from interference of a solar signal with a light signal to generate an electrical response. The method also includes filtering the electrical response to isolate a beat-note signal having an amplitude that is inversely related to a concentration of a species that forms a gaseous plume located along a path of the solar signal.

In a third aspect, a photonic integrated circuit for gaseous leak detection includes a multimode interference coupler, a first grating coupler, a second grating coupler, an output grating coupler, and a detector. The multimode interference coupler has a first input port, a second input port, and an output port. The first grating coupler is coupled to the first input port and couples a solar signal into the multimode interference coupler. The second grating coupler is coupled to the second input port and couples a light signal into the multimode interference coupler. The output grating coupler is coupled to the output port, which outputs an interference signal. The detector is coupled to the output grating coupler, and generates an electrical response to detection of the interference signal

### BRIEF DESCRIPTION OF FIGURES

FIG. 1 illustrates an embodiment of a gas leak detector.

FIGS. 2A and 2B are schematics of a gas leak detector that includes an array of gas leak detectors of FIG. 1, in embodiments.

FIG. 3 is a schematic of a solar tracker present in embodiments of the gas leak detector of FIG. 1.

FIG. 4 is a schematic of a multi-wavelength gas leak detector, which is embodiment of the gas leak detector of FIG. 1.

FIG. 5 is a schematic of electronics, which is an example of electronics of the gas leak detector of FIG. 1.

FIG. 6 is a flowchart illustrating a method for methane leak detection, in an embodiment.

FIG. 7 is a schematic of a photonic integrated circuit for use within the gas leak detector of FIG. 1, in an embodiment.

FIG. 8 is a schematic of a gas leak detector, which is an embodiment of the gas leak detector of FIG. 1.

FIG. 9 is a spectrum of naturally occurring background methane and a fit to the spectrum determined by an embodiment of the gas leak detector of FIG. 8.

FIG. 10 shows spectra of methane at different atmospheric pressures.

FIG. 11 is a plot showing, as a function of altitude, (i) a mixing ratio of background methane and (ii) a mixing ratio of methane injected directly in front of an embodiment of the gas leak detector of FIG. 8.

FIG. 12 is a plot of direct absorption spectra of background methane and with an additional amount of methane directly injected into the detection path of the gas leak detector of FIG. 8.

FIG. 13 is a plot of a wavelength modulation spectroscopy (WMS) 2f signal of methane.

### DETAILED DESCRIPTION OF THE EMBODIMENTS

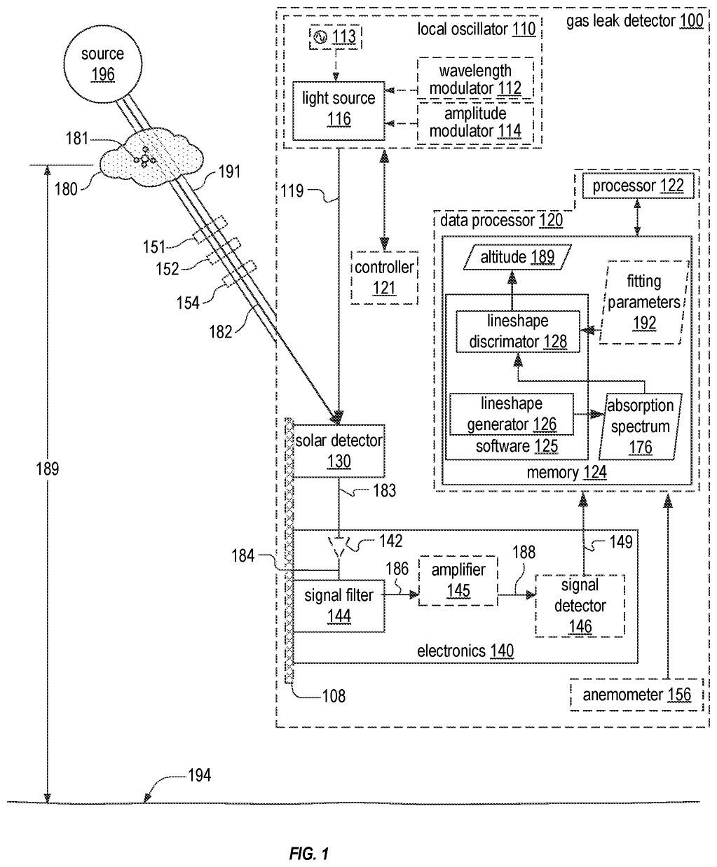

FIG. 1 illustrates a gas leak detector 100 that determines a concentration and location of a gaseous plume 180 that includes a species 181. Plume 180 is located at an altitude 189 above surface 194, which may be a terrestrial surface. Gas leak detector 100 includes a local oscillator 110, a solar detector 130, and electronics 140. Electronics 140 includes a signal filter 144, and may also include at least one of an amplifier 142, an RF amplifier 145, and a signal detector 146.

In an example mode of operation, solar detector 130 generates an electrical response 184 by interfering a light signal 119 with a solar signal 182 propagating from a source 196, which may be the sun. Solar detector 130 may include at least one of an interferometer (e.g., an optical fiber interferometer), a balanced detector, and a product detector. Signal filter 144 filters electrical response 184 to isolate a beat-note signal 186, the amplitude of which is inversely related to (e.g., a decreasing function of) a concentration of species 181 along a path 191 of solar signal 182.

In an embodiment, a local oscillator 110 generates light signal 119 with one or more light-signal frequencies associated with a spectral line of species 181. Examples of gas-phase species include ozone, carbon dioxide, methane, nitrous oxide, water, and dichlorodifluoromethane (CCl₂F₂). A linewidth of light signal 119 may be less than a spectral width of the species 181's spectral line. For example, when species 181 is methane, light signal 119 may have a free-space wavelength between 1630 nm and 1680 nm. A linewidth of light signal 119 may be less than 2 MHz.

In an embodiment, gas leak detector 100 further includes a controller 121 that sets the one or more light-signal frequencies based at least in part on (a) intensity of solar signal 182 and/or (b) target-species concentrations along path 191. Controller 121 may for example set the one or more light-signal frequencies to optimize sensitivity or signal strength of gas leak detector 100. For example, when species 181 is methane, and the solar signal 182 propagates through large target-species concentrations before reaching the solar detector 130, light resonant with methane absorption may be completely absorbed and a different light-signal frequency may produce more sensitive methane leak detection.

Electronics 140 may include a signal detector 146 that detects beat-note signal 186 isolated by signal filter 144. The primary spectral content of beat-note signal 186 may be at radio-frequencies, and thus signal detector 146 may be an RF detector. When detector 100 includes amplifier 145, amplifier 145 amplifies beat-note signal 186 to generate an amplified beat-note signal 188, which is then detected by signal detector 146. In embodiments, detector 100 does not include amplifier 145, and beat-note signal 188 is identical to beat-note signal 186.

In embodiments, at least one of: amplifier 145 is a low noise RF power amplifier; beat-note signal 186 and amplified beat-note signal 188 are RF signals; and solar detector 130 connects with, or includes, amplifier 142. Amplifier 142 amplifies current 183 output by solar detector 130 into usable voltage as electrical response 184, which is received by signal filter 144. Amplifier 142 may be a transimpedance amplifier. In embodiments, detector 100 does not include amplifier 142, and electrical response 184 is identical to current 183.

In embodiments, gas leak detector 100 includes a data processor 120. Electronics 140 outputs an analog signal 149, which data processor 120 processes to determine altitude 189. Data processor 120 includes a processor 122 and a memory 124. Memory 124 stores non-transitory computer-readable instructions as software 125, which includes a lineshape generator 126 and a lineshape discriminator 128. When executed by processor 122, software 125 causes processor 122 to implement selected functionality of gas leak detector 100 as described herein. Software 125 may be, or include, firmware. Controller 121 may be part of data processor 120, for example, as part of software 125.

Data processor 120 is communicatively coupled to electronics 140, e.g., to signal detector 146, to determine altitude 189 of a gaseous plume 180 present along path 191 of solar signal 182. The absorption spectrum plume 180 is affected by total atmospheric pressure of the methane gas at specific altitude. Thus, a plume 180 at high altitudes within earth's atmosphere will be spectrally distinct from a plume of identical species located at low altitudes within earth's atmosphere. Data processor 120 may for example determine an altitude of gaseous plume 180 by comparing an absorption spectrum derived from beat-note signal 186 to previously measured absorption spectra at known pressures.

Memory 124 may store such spectra as a plurality of fitting parameters 192. Fitting parameters 192 may include measured spectra of the same absorption line of species 181, and differ in terms of the atmospheric pressure during measurement. Since atmospheric pressure affects line shape, data processor 120 may use fitting parameters 192 to determine altitude 189 by fitting absorption spectrum 176 to one or more fitting parameters 192. When path 191 traverses multiple gaseous plumes 180 at different altitudes 189, lineshape generator 126 generates, from analog signal 149, absorption spectrum 176 that includes absorption lines of species 181 at different altitudes, and hence different atmospheric pressures. Lineshape discriminator 128 fits absorption spectrum 176 to multiple fitting parameters 192 to determine multiple altitudes at which gaseous plumes 180 are present in addition to background concentrations of species 181.

In embodiments, fitting parameters 192 including broadening coefficients for each of one or more lineshape functions that describe absorption spectrum 176. In such embodiments, fitting parameters 192 may include including broadening coefficients, and not include measured absorption spectra. Example lineshape functions include Gaussian, Lorentzian, and combinations thereof, such as a Voigt profile. For a given species 181, fitting parameters 192 may include a respective broadening coefficient for each of a plurality vibrational and/or rotational modes of species 181 Each broadening coefficient may be a function of atmospheric pressure, such that lineshape discriminator 128 determines, based on absorption spectrum 176, one or more altitudes at which gaseous plumes 180 are present.

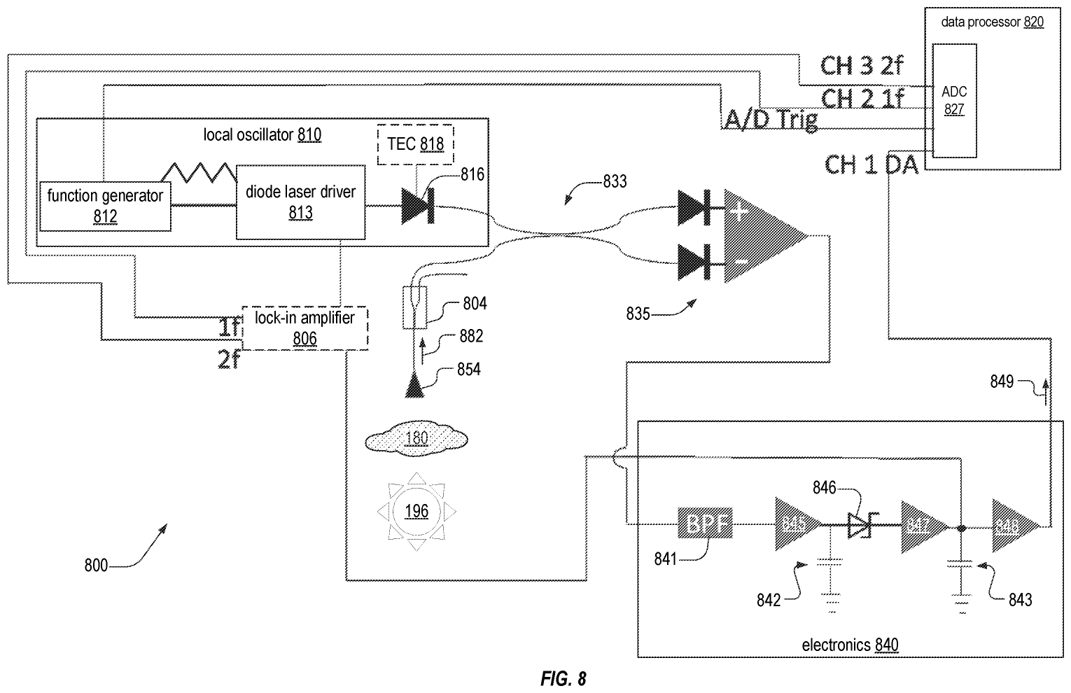

Solar detector 130 and signal filter 144 may be integrated into a PIC 108 to form a photonic integrated circuit (PIC). See also FIG. 7. Processor 120 may receive signals from PIC 108 and make determinations therefrom such as target-species concentrations, methane plume location, and three-dimensional tomographic datasets.

PIC 108 may also integrate at least one of local oscillator 110, controller 121, processor 120, amplifier 145, signal detector 146, and other electronic components of gas leak detector 100. Such integration onto PIC 108 serves several benefits. First, gas leak detector 100 can be small and lightweight when integrated onto a PIC and therefore may be used in aerial drone applications in sensing methane or other target gases. Second, PIC 108 may allow solar detector 130 and amplifier 145 to be closely-coupled to reduce noise and improve overall sensitivity of gas leak detector 100. Third, the size of the solar detector 130 can be reduced, for example, its diameter may be reduced from approximately three-hundred microns to thirty microns. This size reduction reduces the intrinsic capacitance of solar detector 130 based on the areal ratio,

$$( \frac{{π ( 15 \times {10}^{- 6} m )}^{2}}{{π ( 150 \times {10}^{- 6} m )}^{2}} = 0.01 ) ,$$

by a factor of 100. For high-speed detection (e.g., repetition rates greater than a few hundreds of MHz), the reduced capacitance of solar detector 130 translates to lower voltage noise, further improving the signal to noise ratio of gas leak detector 100. Fourth, the likelihood and severity of optical loss between elements of gas leak detector 100 are reduced.

Local oscillator 110 includes a light source 116, and may include at least one of a wavelength modulator 112, an amplitude modulator 114, and a laser driver 113. In embodiments, light source 116 is a scannable single-frequency laser, such as a diode laser, examples of which include a vertical-cavity surface-emitting laser (VCSEL), and a distributed feedback laser.

In embodiments, wavelength modulator 112 modulates frequency of light signal 119, which beneficially allows for lock-in amplification and/or other forms of noise reduction to increase overall sensitivity of gas leak detector 100.

Gas leak detector 100 may include an amplitude modulator 114 that is for example part of local oscillator 110, as shown; though amplitude modulator 114 may be a separate element communicatively coupled to local oscillator 110. In embodiments, amplitude modulator 114 modulates amplitude of light signal 119, which beneficially allows for lock-in amplification and/or other forms of noise reduction to increase overall sensitivity of gas leak detector 100. Amplitude modulator 114 may be an optical chopper that amplitude modulates signal 182 before reaching solar detector 130, which beneficially allows for lock-in amplification and/or other forms of noise reduction to increase the overall sensitivity of gas leak detector 100. Optical chopper 151 may be physically integrated with solar detector 130 and/or PIC 108, or it may be a separate component.

Light source 116 may be temporally-tuned through its wavelength range at a scanning frequency, which may be between 100 Hz and 1 kHz. For example, laser driver 113 may be coupled to light source 116 and operates to temporally tune the center wavelength of light source 116 via a drive signal, which may be a current or voltage that is time-varying, e.g., a periodic waveform.

In an embodiment, gas leak detector 100 includes a spectral filter 152 that transmits solar signal 182 while blocking unwanted portions of broadband emissions from source 196. Spectral filter 152 may be located along path 191 of solar signal 182, unattached to PIC 108, as shown; though spectral filter 152 may be integrated to or with solar detector 130 and/or PIC 108 without departing from the scope hereof.

In an embodiment, gas leak detector 100 includes collection optics 154 located along path 191. Collection optics 154 may be one or more separate optical elements, as shown in FIG. 1, or may be integrated (e.g., as fiber optics) with PIC 108, spectral filter 152 or solar detector 130 without departing from the scope hereof light-collection optics 154 may be a mirror, such as an off-axis parabolic mirror. Collection optics 154 serve to focus solar signal 182 into solar detector 130 to increase efficiency and signal strength, and to reduce noise. Collection optics 154 may be fiber-coupled to solar detector 130.

In the embodiment illustrated in FIG. 1, optical chopper 151, spectral filter 152 and collection optics 154 are positioned so that solar signal 182 interacts with all three, and in this order; though the order of may vary without departing from the scope hereof. Optical chopper 151, spectral filter 152, and collection optics 154 may for example attach to one another or be mounted individually within gas leak detector 100.

In an embodiment, gas leak detector 100 includes an anemometer 156, which may be communicatively coupled to data processor 120. Anemometer 156 assists in locating methane leak location, for example the location of gaseous plume 180. The measured distance and relative location of gaseous plume 180 to gas leak detector 100 varies more dramatically without data from anemometer 156. Anemometer 156 may for example measure wind speed and/or wind direction usable to isolate methane leak location.

As noted above, source 196 may be the sun, which emits radiation traveling directly to gas leak detector 100 after passing through the earth's atmosphere. Source 196 may be the moon, which reflects light emitted from the sun toward, through the earth's atmosphere, and toward gas leak detector 100. When the source 196 is the moon, it may be necessary to use amplifier 145 to generate amplified beat-note signal 188 so that gas leak detector 100 has sufficient sensitivity to detect methane leaks, e.g., gaseous plume 180.

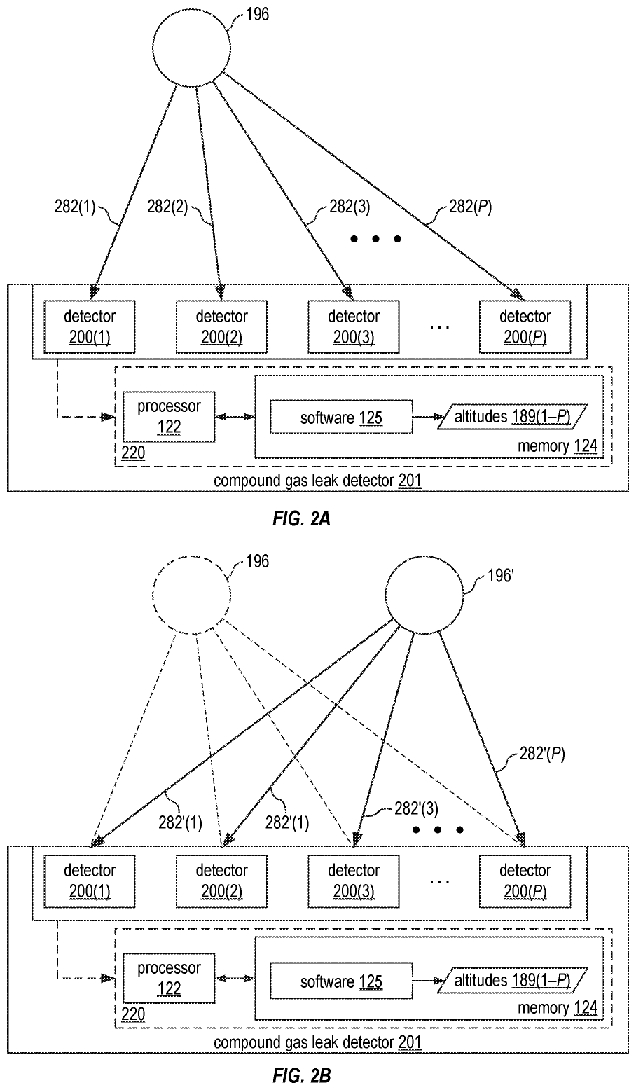

FIGS. 2A and 2B are schematics of a compound gas leak detector 201, which includes an array of gas leak detectors 200. Each gas leak detector 200 is an example of gas leak detector 100 of FIG. 1. FIGS. 2A and 2B illustrate the detector 201 at different times of the day, illustrated by source 196 (e.g., the sun) shown at different positions in the sky. FIGS. 2A and 2B are best viewed together along with the following description. Though FIGS. 2A and 2B illustrates P systems where integer P is at least four, the total number of detectors 200 of compound gas leak detector 201 may be two or three without departing from the scope hereof.

In embodiments, compound gas leak detector 201 includes a data processor 220, which receives respective beat-note signals 186 or 188 from each of detectors 200. Data processor 220 is an example of data processor 120, and determines a respective altitude 189(p) from each detector 200(p), where index p≤P. Data processor 220 may be part of any one of detectors 200, or alternatively be separate from each of detectors 200 such that each detector 200 is communicatively coupled to data processor 220.

Gas leak detectors 200 may be spatially arrayed in one or two dimensions. In FIG. 2A, each gas leak detector 200 receives solar signal 282 (e.g., 282(1), which is an example of solar signal 182); and each gas leak detector 200 isolate a beat-note signal (e.g., beat-note signal 186, FIG. 1) from the solar signal 282 it receives. In FIG. 2A, source 196 emits solar signals 282 to each gas leak detector 200 from its present location; but in FIG. 2B, source 196 has moved across the sky so appears at a different location, and hence is designated as source 196′. Source 196 is shown in FIG. 2B in dotted outline to aid in illustrating the motion of the source (196/196′) across the sky. In FIG. 2B, given the location of source 196′, each gas leak detector 200 receives solar signal 282′ (e.g., 282′(1), which is an example of solar signal 182) from the location of source 196′. Each pair of solar signals (e.g., 282(1) and 282′(1)) are received by each gas leak detector (e.g., 201(1)) at different times of day as earth turns and source 196 traverses the sky.

Accordingly, the plurality gas leak detectors 200, each receiving solar signal 282 at multiple times during the day, constructs a two-dimensional tomographic dataset of the atmosphere viewed by the plurality of gas leak detectors 200. Each point in the two-dimensional tomographic dataset includes a methane concentration present along the path (not shown) of solar signal 282 from the source 196/196′ to the gas leak detector 200 that absorbs it, thus resolving the three-dimensional location (which may include an altitude) of a methane plume (e.g., plume 180, FIG. 1).

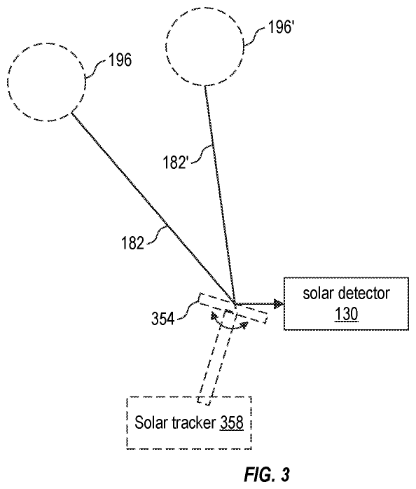

In embodiments, detector 100 includes a solar tracker 358 used to maximize intensity of a solar signal 182/182′ into solar detector 130. In the embodiment shown in FIG. 3, solar tracker 358 includes a light-collection optic 354 that directs solar signals 182/182′ into the solar detector 130 as a solar source 196 moves. light-collection optic 354 is an example of collection optics 154. In another embodiment, solar tracker 358 moves solar detector 130 directly (not shown) so that solar detector 130 is best positioned to receive solar signals 182/182′ while source 196 moves. Thus, solar signal 182 is emitted from source 196 at a first time and solar signal 182′ is emitted from source 196′ a second time; source 196 and 196′ is the same physical object that moves with respect to solar detector 130 over a given time period.

Operationally, solar tracker 358 maximizes intensity of solar signals 182/182′ reaching the solar detector 130 using (a) solar data indicating position of source 196/196′ of the solar signal 182/182′ with respect to solar detector 130 and/or (b) intensity of solar signal 182/182′ reaching solar detector 130 at a given time. Solar tracker 358 may for example make use of known astronomical data to position light-collection optic 354 (in the embodiment illustrated in FIG. 3) or solar detector 130 (in the alternative embodiment) maximize the amount of the solar signal 182/182′ into the solar detector 130. Additionally, or instead, the solar tracker 358 may iteratively control the position of solar signal 182/182′ into solar detector 130 using intensity of solar signal 182/182′ reaching solar detector 130 at a given time, meaning it iteratively improves the alignment based on recent measurement and alignment.

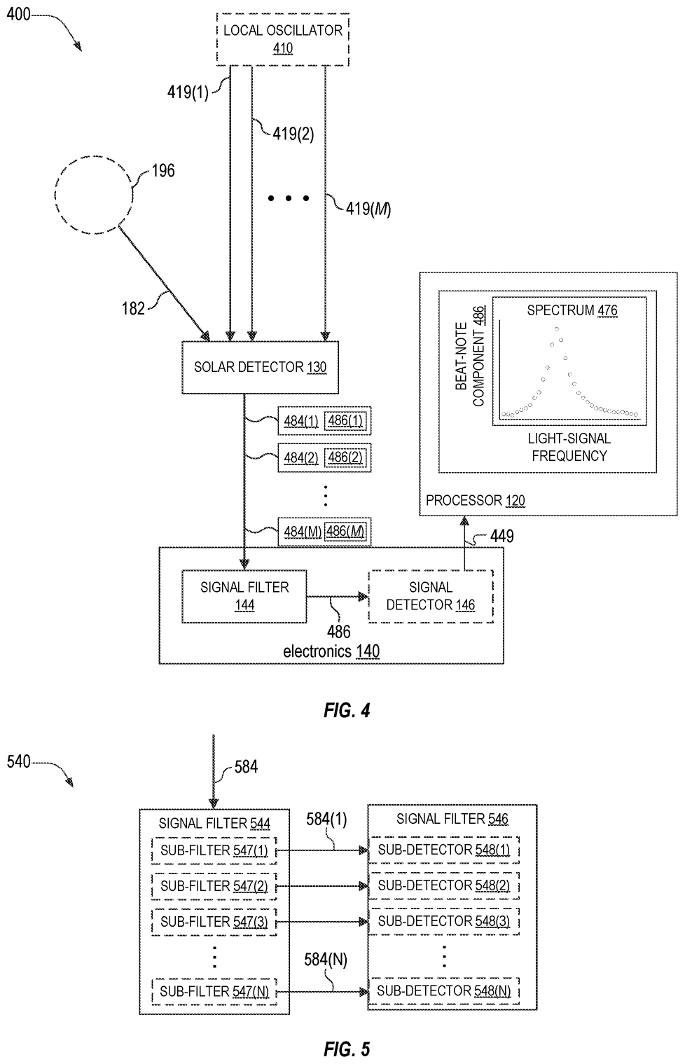

FIG. 4 illustrates a multi-wavelength gas leak detector 400 that includes a local oscillator 410, which generates a plurality of light signals 419(1, 2, . . . , M) that have a respective one of M center wavelengths. Gas leak detector 400 and local oscillator 410 are respective examples of gas leak detector 100 and local oscillator 110. In embodiments, local oscillator 410 includes at least one light source, such as any combination of single-frequency lasers and tunable lasers, that collectively produce each light signal 419. In a first example, local oscillator 410 may include a single tunable laser that produces each light signal 419. In a second example, local oscillator 410 may include M light sources, e.g., M single-frequency lasers, each of which produces a respective light signal 419.

The plurality of light signals 419 are received by solar detector 130, which mixes each of light signals 419 with solar signal 182 to generate one of a plurality of electrical responses 484(1-M), each containing a respective beat-note signal 486 to form a plurality of beat-note signals 486(1-M). Signal filter 144 filters each of the plurality of electrical responses 484, to isolate its respective beat-note signal 486 to be recorded by signal detector 146. Signal detector 146 records each beat-note signal 486 and outputs an analog signal 449 to processor 120. Analog signal 449 is an example of analog signal 149.

For example, local oscillator 410 generates light signal 419(2), which is mixed with solar signal 182 to generate electrical response 484(2) that contains beat-note signal 486(2). Signal filter 144 isolates beat-note signal 486(2), which is recorded by signal detector 146 and transmitted to processor 120 as analog signal 449. When each of the plurality of beat-note signals 486 is plotted with respect to the light-signal frequency of corresponding light signal 419, a spectrum 476 is generated. Spectrum 476 is an example of absorption spectrum 176.

FIG. 5 is a schematic of electronics 540, which is an example of electronics 140, FIG. 1. Electronics 540 includes signal filter 544 and signal detector 546, which are respective examples of signal filter 144 and signal detector 146. Signal filter 544 includes a plurality of sub-filters 547. Signal detector 546 includes a plurality of sub-detectors 548. Each of the plurality of sub-filters 547 is associated with a respective frequency range to isolate a corresponding frequency-domain portion of an electrical response 584, which is an example of electrical response 184. For example, sub-filter 547(2) isolates a portion of the electrical response 584(2).

Each sub-detector 548(n) is communicatively coupled to one sub-filter 547(N), as shown, where index n≤N. Each of the sub-detectors 548(n) records the portion of electrical response 584(n) isolated by its corresponding sub-filter 547(n). For example, sub-detector 548(2) communicatively couples to sub-filter 547(2) and thereby is able to detect the corresponding portion of electrical response 584(2). Portions of electrical response 584 recorded by the sub-detectors 548, when graphed versus frequency ranges of the corresponding sub-filter 547, generates spectrum 476, FIG. 4.

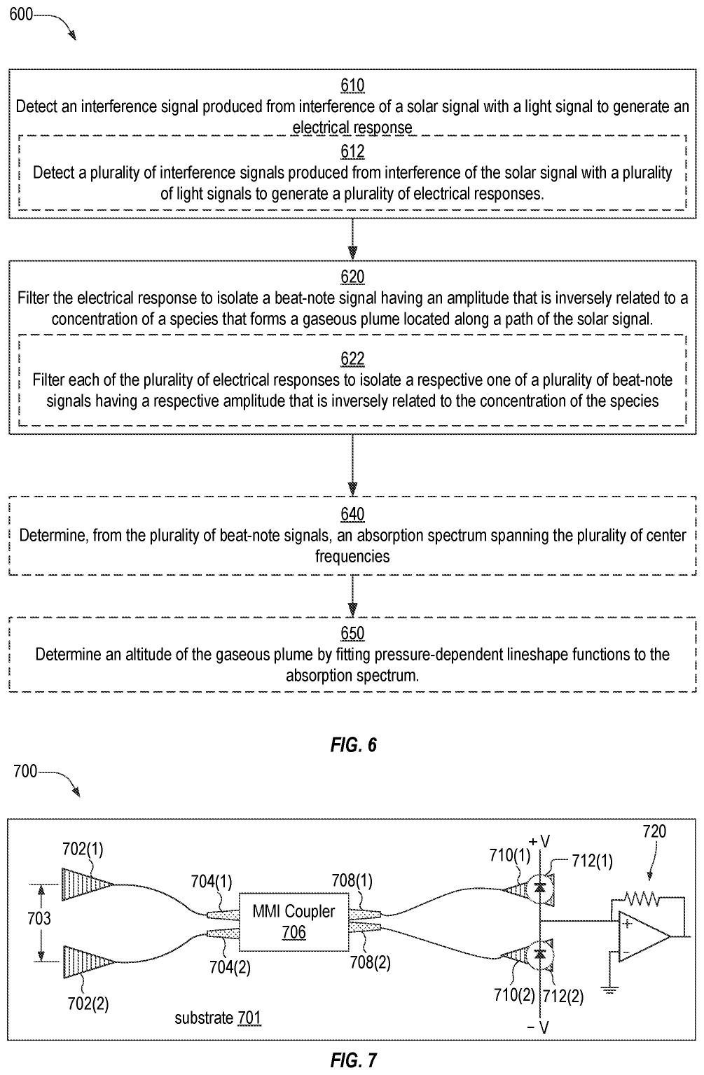

FIG. 6 is a flowchart illustrating a gas leak detection method 600. In some implementations, one or more process blocks of FIG. 6 may be performed by an embodiment of gas leak detector 100. In some implementations, one or more process blocks of FIG. 6 may be performed by another device, or a group of devices separate from or including gas leak detector 100. Additionally, or alternatively, one or more process blocks of FIG. 6 may be performed by one or more components of gas leak detector 100.

As shown in FIG. 6, method 600 may include detecting an interference signal produced from interference of a solar signal with a light signal to generate an electrical response (block 610). In an example of block 610, gas leak detector 100 detects an interference signal produced from interference of solar signal 182 with a light signal 119 to generate electrical response 184.

As further shown in FIG. 6, method 600 may include filtering the electrical response to isolate a beat-note signal having an amplitude that is inversely related to a concentration of a species that forms a gaseous plume located along a path of the solar signal (block 620). In an example of block 620, gas leak detector 100 filters electrical response 184 to isolate beat-note signal 186, which has an amplitude that is inversely related to a concentration of species 181.

Method 600 may include additional implementations, such as any single implementation or any combination of implementations described below and/or in connection with one or more other processes described elsewhere herein.

In a first implementation, method 600 includes generating, with a local oscillator, the light signal having a light-signal frequency associated with species absorption. For example, local oscillator 110 generates light signal 119. In this implementation, method 600 may include selecting the light-signal frequency based at least in part on one or more or more of (a) intensity of the solar signal and (b) the concentration of species 181.

In a second implementation, method 600 includes determining a location of a gaseous plume corresponding to the species concentration, where said determining is based at least in part on atmospheric pressure. In a third implementation, method 600 includes detecting, with a plurality of sub-detectors each communicatively coupled to one of a plurality of sub-filters, a corresponding portion of the electrical response isolated by a corresponding sub-filter, as described in FIG. 5 for example. In a fourth implementation, method 600 includes modulating the light signal to allow increased sensitivity.

In a fifth implementation, block 610 includes detecting a plurality of interference signals produced from interference of the solar signal with a plurality of light signals to generate a plurality of electrical responses, each of the plurality of light signals each having a respective one of a plurality of center frequencies (block 612). In an example of block 612, gas leak detector 400, FIG. 4, detects interference signals produced from interference of solar signal 182 with light signals 419 to generate electrical responses 484.

In the fifth implementation, block 620 includes filtering each of the plurality of electrical responses to isolate a respective one of a plurality of beat-note signals having a respective amplitude that is inversely related to the concentration of the species (block 622). The plurality of interference signals, the plurality of light signals, and the plurality of beat-note signals including the interference signals, the light signal, and the beat-note signal, respectively. In an example of block 622, gas leak detector 400 filters electrical responses 484 to isolate beat-note signals 486, each of which has an amplitude that is inversely related to a concentration of species 181.

In embodiments of the fifth implementation, method 600 includes determining, from the plurality of beat-note signals, an absorption spectrum spanning the plurality of center frequencies (block 640). For example, lineshape generator 126 determines absorption spectrum 176 from analog signal 449 received by processor 120 of gas leak detector 400. Such embodiments may also include determining an altitude of the gaseous plume by determining an altitude of the gaseous plume by fitting pressure-dependent lineshape functions to the absorption spectrum (block 650). For example, lineshape discriminator 128 determines altitude 189 by comparing absorption spectrum 176 to fitting parameters 192.

Such embodiments may include determining an altitude of the gaseous plume by comparing the absorption spectrum to a plurality of reference absorbance spectra of the species at a respective one of plurality of atmospheric pressures. For example, lineshape discriminator 128 determines altitude 189 by comparing absorption spectrum 176 to fitting parameters 192, where fitting parameters 192 include the aforementioned plurality of reference absorbance spectra of the species.

In an eighth implementation, method 600 includes determining a location of the gaseous plume from the altitude, an elevation angle of a source of the solar signal, and a direction of the source relative to a device that detects the interference signal. In an example of this implementation, memory 124 stores the direction and elevation angle, and determines the location of gaseous plumes 180.

In a ninth implementation, method 600 includes the eight implementation and also includes generating a three-dimensional tomographic dataset of a plurality of gaseous plumes by, for each of the plurality of gaseous plumes determining a respective location of the gaseous plume by executing the eight implementation of method 600.

In a tenth implementation, method 600 includes the eight implementation and also includes measuring wind velocity, and determining the location comprising determining a location from the altitude, the elevation angle, and the direction. In an example of this implementation, anemometer 156 determines wind velocity.

Although FIG. 6 shows example blocks of method 600, in some implementations, method 600 may include additional blocks, fewer blocks, different blocks, or differently arranged blocks than those depicted in FIG. 6. Additionally, or alternatively, two or more of the blocks of method 600 may be performed in parallel.

As noted above, solar detector 130 and signal filter 144 may be integrated into a single photonic integrated circuit (PIC) with advantageous benefits. Signals from the PIC may be interpreted and processed (e.g., by processor 122, FIG. 1) to isolate methane plume location such as in a three-dimensional tomographic dataset.

FIG. 7 illustrates one such PIC 700, but without a local oscillator 110 and other components, which may be off-chip instead. Components of PIC 700 reside on an insulating substrate 701 (e.g., silicon, silicon dioxide (Si, SiO₂), though other materials may be suitable including silicon nitride, silicon oxide, sapphire, aluminum nitride, germanium, and silicon germanium alloy). These components include grating couplers 702(1,2), input waveguides 704, multimode interference coupler 706, output waveguides 708(1,2), grating couplers 710, detectors 712(1,2) and a transimpedance amplifier (TIA) 720. In embodiments, solar detector 130 includes multimode interference coupler 706 and electronics 140 includes detectors 712 and TIA 720.

The split ratio of multimode interference coupler 706 may be 50/50. Waveguides 704 and 708 may be formed of silicon. In embodiments, detectors 712 are semiconductor-based photodetectors, where the semiconductor may be indium gallium arsenide. Detectors 712 may be attached to substrate 701 via flip-chip bonding. TIA 720 may be on PIC 700, as shown, or off-chip, such as amplifier 145, FIG. 1.

Grating couplers 702(1) and 702(2) are spaced apart by a pitch 703, which may be between 200 μm and 300 μm, e.g., 250 μm. Grating couplers 702(1,2) respectively couple electromagnetic energy from solar signal 182 and light signal 119 (from local oscillator 110) into PIC 700. Electromagnetic energy output from couplers 702(1), 702(2) travels along input waveguides 704(1), 704(2) into multimode interference coupler 706, so that combined signals are equally half power at output waveguides 708(1), 708(2) and into respective detectors 712(1), 712(2) with heterogeneous integration. Output from detectors 712 couple into a TIA 720, thereby facilitating connections to off-chip radio frequency domains. Though two detectors 712 are shown, one may be used instead depending on signal to noise ratio (SNR). Integrating TIA 720 on PIC 700 reduces distance between detector(s) 712 and TIA 720, again reducing noise. In comparison to FIG. 1, the remaining RF detection train (RF amplifier 145, signal detector 146, data processor 120) are off of PIC 700 so as to easily switch between amplifier gains and filter bandwidths. However, as in FIG. 1, all components may instead reside on chip (e.g., PIC 108).

FIG. 8 is a schematic of a gas leak detector 800, which is an example of gas leak detector 100. Gas leak detector 800 includes local oscillator 810, a 2×2 coupler 833, a balanced detector 835, electronics 840, and a data processor 820.

Local oscillator 810 is an example of local oscillator 110, and includes a function generator 812, a diode laser driver 813, and a single mode (SM), fiber-coupled, distributed feedback (DFB) laser 816. Local oscillator 810 may also include a thermoelectric cooler 818 coupled to DFB 816. DFB laser 816 may have a 2-MHz bandwidth. Data processor 820 is an example of data processor 120, and includes an analog-to-digital converter 827. Diode laser driver 813 and DFB laser 816 are respective examples of laser driver 113 and light source 116.

Gas leak detector 800 may also include at least one of an off-axis parabolic mirror 854 and a 1×2 fiber-optic switch 804. Switch 804 may be remotely operated. Electronics 840 includes an RF detector 846 and least one of: a bandpass filter 841, a lowpass filter 842, a lowpass filter 843, an amplifier 845, an amplifier 847, and an amplifier 848. RF detector 846 is an example of signal detector 146. Mirror 854 is an example of, or may be part of, collection optics 154.

The following describes an example mode of operation of gas leak detector 800. In this example, species 181 of gaseous plume 180 is methane. Light from local oscillator 810 is mixed in coupler 833 with a solar signal 882 sunlight collected into a single-mode using mirror 854, which in this example has a 33-mm focal length. Solar signal 882 is an example of solar signal 182. Fiber-optic switch 804 enables sampling the RF background offset level intermittently, which is affected by the temperature of the RF detector. The RF offset needs to be taken into account to accurately fit the lineshape of a target species of plume 180. Both output legs of coupler 833 provide the dual inputs to balanced detector 835.

In embodiments, off-axis parabolic mirror 854 tracks source 196 by piggy-backing on a GPS-enabled commercial telescope with an alt/azimuth mount using a micro-controller-based tracking capability. The tracking system automatically follows the known position of source 196 based on the date, time, and latitude after initial alignment. The direct absorption (DA) signal is collected with the fast sinusoidal modulation voltage set to zero.

Function generator 812 synthesizes a 200-Hz triangle wave as input to diode laser driver 813. The resulting current modulation repetitively scans DFB laser 816 over approximately the wavelength range from 1665.868 nm to 1666.075 nm covering the CH₄2ν₃ overtone Q(6) transitions centered at 1665.956 nm. Light from DFB laser 816 is combined with light from source 196 to form an RF beat note or intermediate frequency, IF. Imprinted on the envelope of the beat note is any lined absorption that occurs as sunlight transits the atmosphere. Filters cut off IF frequencies above 225 MHz leaving a narrow range of frequencies centered on the instantaneous wavelength of DFB laser 816. DFB laser 816 is then swept at 200 Hz across the Q(6) features to generate the spectrum of interest. The data is digitized by a 2 MS/sec A/D converter, which is triggered to collect and column average the spectral data synchronously with the LO 200 Hz sweep. The A/D converter may be part of data processor 120.

The collected data is fit using a retrieval program, stored as software 125, to determine the methane mixing ratio versus altitude 189 in the following way. The actual atmospheric vertical column is approximated using the U.S. Standard Atmosphere (1826 version) up to the top of the stratosphere (50 km). This standard atmosphere is divided into equal average ρᵢΔZᵢ layers; that is, the average density in layer i multiplied by the vertical depth of layer i is equal for all layers i=1, . . . , N. The number of layers N is arbitrary, but for our data analysis here, we have used N=11 for reasons described below. As a result, the layers closer to the surface are shallower and the layers are deeper at higher altitudes. For example, when there are only two layers (N=2) the bottom layer is 5.6 km and the top layer is 44.4 km in depth. By dividing the vertical column in this manner, the different layers contribute nearly equal changes in integrated methane absorbance for a given change in methane concentration within the layer.

The retrieval algorithm, stored as part of software 125, calculates a model of the vertically integrated methane absorption spectrum by summing the absorbance over N (equal ρᵢΔZᵢ) layers from the surface up to an altitude of 50 km. This model is used to fit the actual, measured POHS methane absorption spectrum using a Levenberg-Marquadt algorithm. The routine varies the fit parameters in order to minimize the (squared) difference between the model and the measured spectrum, and the N layer methane concentrations are fit parameters.

A vertical profile of atmospheric methane results from fitting a given, measured spectrum. The profile is not sensitive to reasonable initial conditions; for results shown here, we assume a methane concentration equal to 1.8 ppm for all layers. The vertical profile of methane resulting from fitting a given measured spectrum remains similar while increasing the number of layers beyond 10 (N>10), although profiles are naturally smoother with increasing N. Because the problem is mathematically under-determined with the small number of spectral features available in the scan range of our laser, we choose to keep the number of layers as small as possible while still reproducing the major features of the profile. We modelled all results using 11 bins.

Balanced detector 835, electronics 840, and data processor 120 determine the spectral bandwidth of gas leak detector 800. Balanced detector 835 receives the light from the two output legs of 2×2 coupler 833. These optical outputs are intrinsically of opposite phase. The common mode noise is eliminated, and the signal is reinforced by subtracting the photodiode signal from the two inputs. The output bandwidth of the balanced detector 835 may be 400 MHz. The output of balanced detector 835 is then bandpass filtered by bandpass filter 841 (bandwidth is 20 MHz-1 GHz in this example), amplified in RF power amplifier 845 (+30 dB power gain, 10 MHz-1 GHz, in this example), and then low-pass filtered by lowpass filter 842 at an adjustable frequency that determines the spectral resolution of gas leak detector 800.

In embodiments, the cutoff frequency of lowpass filter 842 is between 52 MHz and 225 MHz. In this range, the bandwidth of gas leak detector 800 does not cause broadening of the measured methane spectral profile. Yet, a drawback of lower cutoff frequencies is decreased signal amplitude. The low-pass filtered signal power is converted to a voltage at RF detector 846, which may include a zero-bias Schottky diode, a bandwidth of which may span 10 MHz to 2 GHz. The voltage output of RF detector 846 is then amplified and filtered through amplifier 847, lowpass filter 843, and amplifier 848 to yield an output analog signal 849, which is an example of analog signal 149. In this example, the amplification and filtering yield a 1472× increase in voltage with an output bandwidth that is less than 70 kHz.

Analog signal 849 is then directed to one of the input channels of an A/D converter of data processor 120, in which it is synchronously digitized and column averaged. Operating at 200 Hz and averaging for 1000 scans leads to a 5 second acquisition sequence. In FIG. 8, all leads are electrical connections, expect for (a) those between DFB laser 816 and balanced detector 835 and (b) those between off-axis parabolic mirror 854 and balanced detector 835, which are optical components/connections. The electrical components dominate, which is one of the main advantages of detector 100 and will allow the large-scale lab instrument to be miniaturized to a single-board, purpose-built sensor.

Gas leak detector 800 may also include a digital lock-in amplifier 806 for collection of the wavelength modulation spectroscopy (WMS) 1f and 2f signals. Amplifier 806 is communicatively coupled to lowpass filter 843 and data processor 120. In this example, amplifier 806 produces a fast sinusoidal modulation waveform which is imprinted on the 200-Hz sweep by a bias T circuit in diode laser driver 813. Amplifier 806 also allows phase to be adjusted to maximize the 1f and 2f X̅ signal components. The optimal phase changes as the electronics configuration determining the bandwidth changes but is constant thereafter. Therefore, only a single lock-in measuring the X̅ components of the signal is required. We operate at a modulation voltage of up to 700 mV (78 pm modulation depth) at a frequency of about 45 kHz. The 1f and 2f outputs of amplifier 806 are directed to channels 2 and 3 of A/D converter 827 where they are likewise digitized and column averaged. When collecting direct absorption data, the fast modulation voltage on amplifier 806 is set to zero to avoid broadening the methane spectral features.

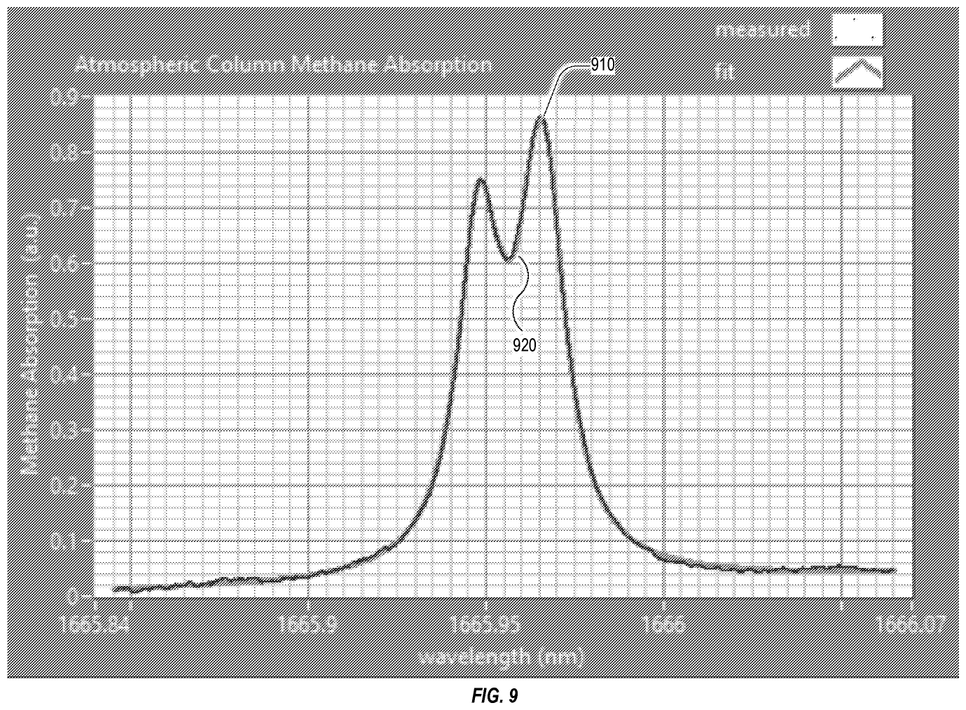

FIG. 9 shows a spectrum 910 (black curve) of naturally occurring background methane which occurs at a ground level concentration of approximately 1.8-2.0 ppm on the CH₄2ν₃ Q(6) transitions centered at 1665.956 nm. The spectroscopy of the Q(6) transitions is well known. It consists to two groups of three lines that are closely spaced giving rise to peaks at approximately 1665.948 and 1665.967 nm at our spectral resolution. Fitted spectrum 920 (gray curve) is a fit to spectrum 910 using our retrieval algorithm, which is stored as software 125.

All six lines are part of the Q-branch of the 2ν₃ overtone band (2 quanta of asymmetric stretch) and emanate from the vibrationless, nearly degenerate lower state level with E″=219.9 cm⁻¹. Spectrum 910 is the data acquired by an embodiment of detector 100 on 22-May 2021 at 10:18:54 AM MDT. It consists of only the background methane signal present at that time and spatial direction which is determined by the position of the sun relative to detector 100. Fitted spectrum 920 is the retrieved spectral fit. As can be seen, the fit is good at the noise level of the spectrum which was acquired by averaging 1,000 scans over 5 seconds. This spectral region was chosen because it consists of two, closely-spaced features at 450 MHz spectral resolution that are nevertheless well resolved at low pressure (high altitude) and blend into a single feature near atmospheric pressure (low altitude). This pressure dependence provides a means to determine the approximate altitude of the methane which, with positional data on the elevation angle of the sun and its direction relative to detector 100, allows one to calculate the location of any anomalous sources of methane.

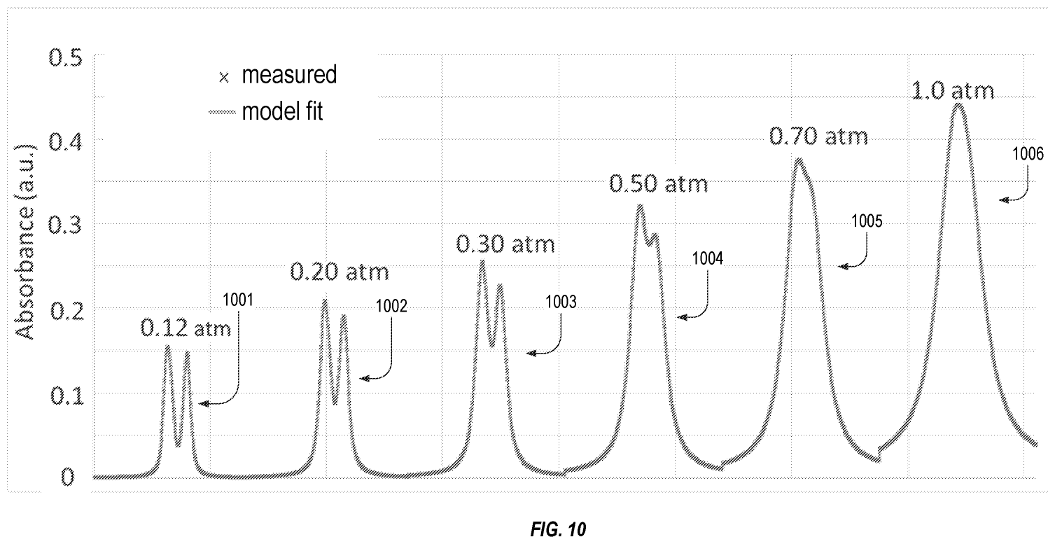

Our efforts to determine better broadening coefficients resulted in the data shown in FIG. 10, which includes reference spectra 1001-1006 of the 2ν₃ Q(6) lines centered at 1665.956 nm. Each reference spectrum 1001-1006 is an example of a spectrum of fitting parameters 192. In embodiments, fitting parameters 192 include broadening coefficients determined from spectra 1001-1006. The spectra are acquired at 0.12, 0.2, 0.3, 0.5, 0.7, and 1.0 atmosphere total pressure. These pressures roughly correspond to altitudes of 16 km, 12 km, 9 km, 7 km, 3 km, and 0 km, respectively. The scan range for each spectrum is identical—approximately 1666.035 to 1665.879 nm. Each scan's wavelength range is the reverse of that shown in FIG. 9—an artifact of the data collection method.

To generate FIG. 10, the Q(6) lines were scanned repetitively at pressures from 0.12 to 1.0 atmosphere using a standard TDLAS system and a multi-pass cell in which we can control the composition, temperature, pressure, and path length of the methane sample. To make these measurements, we started with a calibrated bottle of 5% methane in nitrogen and flow diluted the methane with nitrogen using calibrated mass flow controllers until we achieved a 1% methane concentration—so the broadening coefficients that we determined were for nitrogen; not air. The concentration was verified using tunable diode laser measurements with direct detection at the same wavelength (approximately 1666 nm) as the laser heterodyne radiometry (LHR) measurements made by detector 100. The laser was double-passed in our spectroscopy cell to achieve a path length of 1.22 meters. The concentration remained constant at 1% for all measurements; only the pressure was varied for the different runs. From these measurements, we learned that it is insufficient to model the Q(6) features as two groups of three very closely spaced peaks even though the triad of peaks is completely unresolved. Instead, we had to model all six features independently with individual positions, and broadening parameters, although the final line broadening parameters were similar to the values of the high-resolution transmission molecular absorption database (HITRAN).

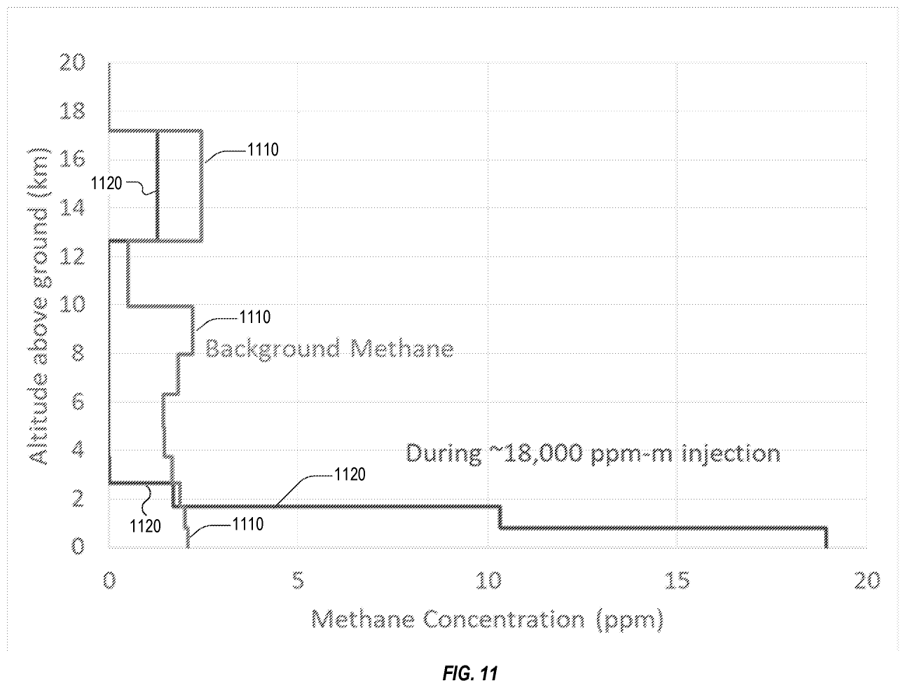

The retrieval algorithm described above analyzed the spectral profile of FIG. 9 yielding the methane mixing ratio versus altitude (pressure) shown in FIG. 11. FIG. 11 is a plot of (i) background methane mixing ratio versus altitude (trace 1110) and (ii) methane mixing ratio with approximately 18,000 ppm-m of methane at room temperature and local atmospheric pressure injected directly in front of off-axis parabolic mirror 854 (trace 1120). The dramatic difference between the profiles indicates that we can detect small levels of excess methane and approximately determine the altitude of the excess methane. The mixing ratio versus altitude profile that we determine from the retrieval algorithm of the background methane is in line with expectations based on earlier work.

To test the ability of our LHR to see an anomalous methane “leak”, we obtained normal background spectra as in FIG. 9 and compared them to spectra obtained by inserting a 10-cm spectroscopic cell filled with 5% methane (5000 ppm-m) in nitrogen at room temperature and local atmospheric pressure (0.83 atm.) or by injecting approximately 18,000 ppm-m of methane directly into the path of the LHR collection optic. The concentration of the injected methane is calculated from the flow of methane, 500 standard liters/minute (slm) (21.4 kg/hr), and the diameter of the injection pipe (5 cm) using computational fluid dynamics calculations. This leak level is less than half of the super-emitter definition, >50 kg/hr.

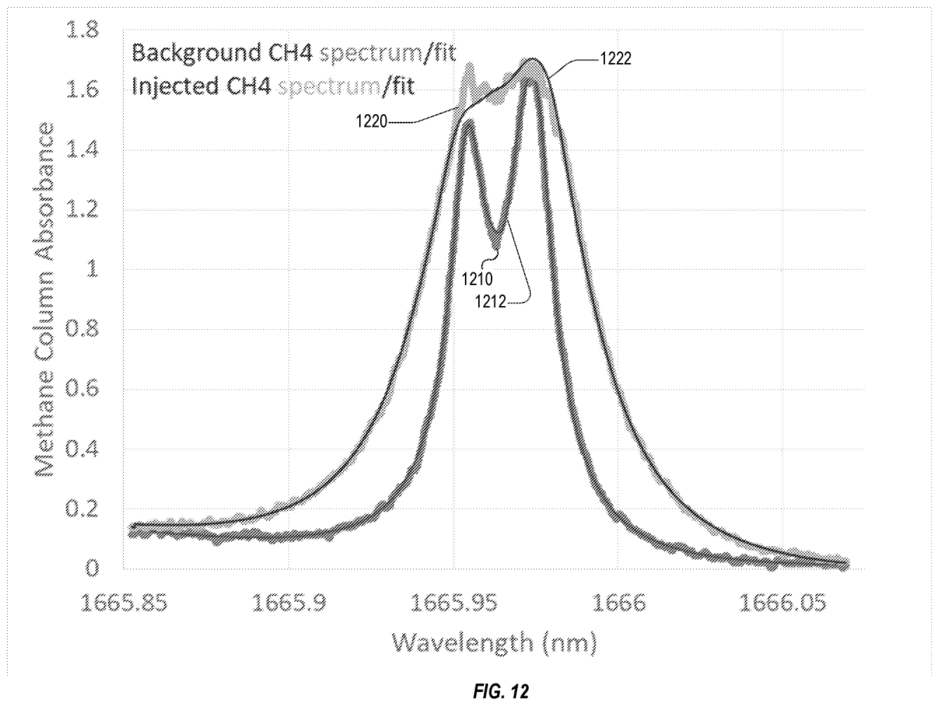

We also detected leaks at the 13 kg/hr (300 slm) level. The resulting spectra without and with the injected methane are shown in FIG. 12. FIG. 12 is a plot of direct absorption (DA) spectra of background methane (trace 1210) and with an additional amount of methane equal to about 18,000 ppm-m from direct injection of methane into the detection path of gas leak detector 800 (trace 1220). FIG. 12 also includes retrieval fits 1212 and 1222 to traces 1210 and 1220 respectively. If one compares the spectra, it is clear that the additional methane increased the absorbance roughly in line with expectations and also greatly broadened the lineshape.

### WMS Laser Heterodyne Radiometry Data

We suspected that the WMS 1f and 2f LHR signals might be advantageous to collect as WMS overcomes certain types of noise allowing smaller signals to be detected with reasonable signal-to-noise ratio. We collected 2f spectra with the methane cell in and out of the path.

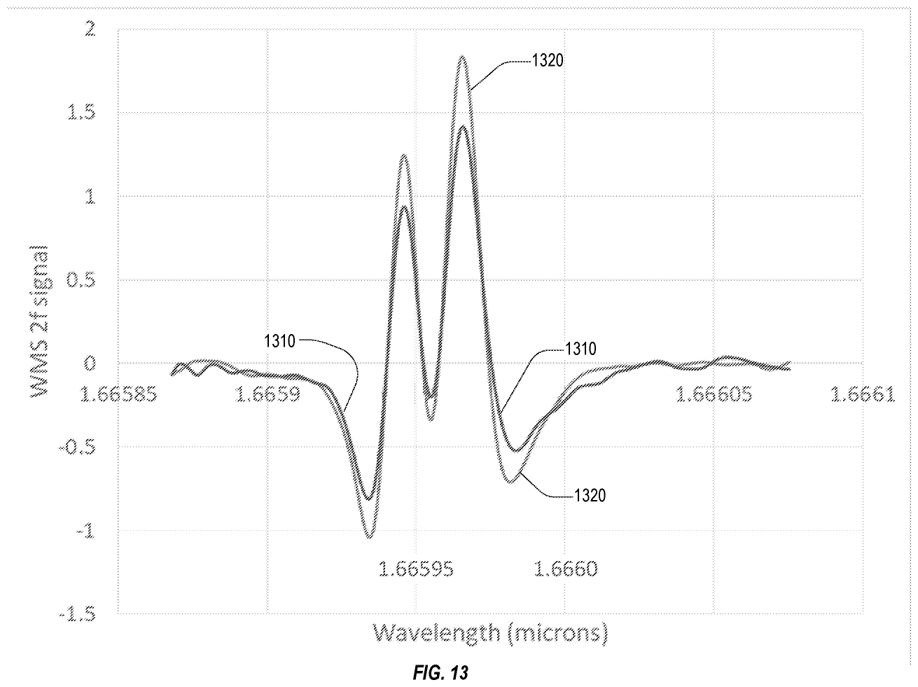

FIG. 13 is a plot of the WMS 2f signal with (signal 1310) and without (signal 1320) the 10 cm-cell filled with 5% methane at 0.83 atmospheres and room temperature. The modulation depth was low (18 pm for this scan) which preserves the essential features of the lineshape well. Larger modulation depth increases the signal but obscures the details of the lineshape which are particularly relevant for plume localization efforts.

We expected that the peak-to-peak 2f signal would be larger due to the additional methane in the cell. Contrary to our expectations, as shown in FIG. 13, the peak-to-peak 2f methane signal (and the wavelength-integrated 2f signal) actually decreases when the methane cell is inserted. This initially surprising result may be understood as follows. The 2f signal is essentially the second derivative of the direct absorption spectrum. Mathematically, the second derivative is a measure of the curvature of the lineshape. Since the added methane exhibits a broad lineshape relative to the integrated atmospheric column, the curvature of the lineshape decreases when the methane cell is inserted leading to a smaller 2f signal.

This would seem to make the 2f and 1f signals useless for detecting and locating methane leaks; however, consider the following. If the direct absorption (DA) signal indicates an increase in absorbance and the 2f peak-to-peak amplitude decreases, it suggests that the additional methane is close to the ground (also indicating that it is close to gas leak detector 100. Taking this information along with the altitude and azimuthal angles of the sun, simple trigonometry allows calculation of the approximate location of the leak. If the additional absorbance is accompanied by an increase in the 2f signal, it indicates that the additional methane is at high altitude (far from detector 100). This information is supplementary to the retrieval profile and should help in plume localization.

### Combination of Features

Features described above as well as those claimed below may be combined in various ways without departing from the scope hereof. The following enumerated examples illustrate some possible, non-limiting combinations:

(A1) A gas leak detector includes: a solar detector that generates an electrical response by interfering a light signal with a solar signal and detecting a resultant interference signal; and a signal filter, communicatively coupled to the solar detector, that filters the electrical response to isolate a beat-note signal having an amplitude that is inversely related to a concentration of a species that forms a gaseous plume located along a path of the solar signal.

(A2) The embodiment (A1) further including a local oscillator that generates the light signal, the light signal having a light-signal frequency corresponding to a resonance absorption of the species.

(A3) Either one of embodiments (A1) or (A2) further including a controller communicatively coupled to the local oscillator that sets the light-signal frequency based at least in part on one or more of (a) intensity of the solar signal and (b) target-species concentration.

(A4) Any one of embodiments (A1)-(A4) further including a light source; and a laser driver that tunes a frequency of the light source such that (i) the local oscillator generates a plurality of light signals each having a respective one of a plurality of center frequencies, (ii) the solar detector generates a respective one of a plurality of electrical responses by mixing each of the plurality of light signals with the solar signal, and (iii) the signal filter filters each of the plurality of electrical responses to isolate a respective one of a plurality of beat-note signals,

(A5) Any one of embodiments (A1)-(A5) further including a signal detector that records each of the plurality of beat-note signals; and a processor communicatively coupled to the signal detector; and a memory storing (i) a plurality of reference absorbance spectra of the species at a respective one of plurality of atmospheric pressures, and (ii) machine readable instructions that when executed by the processor, cause the processor to:

(B1) A gas leak detector comprising: an array of gas leak detectors of embodiment (A4), each of which generates a respective plurality of beat-note signals associated with a respective one of a plurality of gaseous plumes that includes the gaseous plume; a signal detector that records each of the respective pluralities of beat-note signals; and a processor communicatively coupled to the signal detector; a memory storing machine readable instructions that when executed by a processor, cause the processor to generate a three-dimensional tomographic dataset of the plurality of gaseous plumes by, for each of the plurality of gaseous plumes: determine, from the plurality of beat-note signals, an absorption spectrum spanning the plurality of center frequencies; and determine an altitude of the gaseous plume by at least one of (i) fitting pressure-dependent lineshape functions to the absorption spectrum and (ii) comparing the absorption spectrum to a plurality of reference absorbance spectra of the species at a respective one of plurality of atmospheric pressures

(B2) The embodiment (B1) further including a signal detector communicatively coupled to the signal filter, that records the beat-note signal.

(B3) Either one of embodiments (B1) or (B2) further including a photonic integrated circuit that includes the solar detector and signal filter.

(B4) Any one of embodiments (B1)-(B4) further including an anemometer that assists in locating methane leak location.

(C1) A method for detecting a gas leak includes: detecting an interference signal produced from interference of a solar signal with a light signal to generate an electrical response; and filtering the electrical response to isolate a beat-note signal having an amplitude that is inversely related to a concentration of a species that forms a gaseous plume located along a path of the solar signal.

(C2) The embodiment (C1) further including the method includes generating, with a local oscillator, the light signal having a light-signal frequency associated with species absorption.

(C3) Either one of embodiments (C1) or (C2) further including the method includes selecting the light-signal frequency based at least in part on one or more or more of (a) intensity of the solar signal and (b) the concentration of the species.

(C4) Any one of embodiments (C1)-(C4) further including the method includes determining location of a gaseous plume corresponding to the concentration of the species, said determining based at least in part on atmospheric pressure.

(C5) Any one of embodiments (C1)-(C5) further including the method includes detecting, with a plurality of sub-detectors each communicatively coupled to one of a plurality of sub-filters, a corresponding portion of the electrical response isolated by a corresponding sub-filter.

(C6) Any one of embodiments (C1)-(C6) further including the method includes amplitude modulating the light signal to allow increased sensitivity.

(C7) In any one of embodiments (C1)-(C7), the method includes detecting an interference signal comprising: detecting a plurality of interference signals produced from interference of the solar signal with a plurality of light signals to generate a plurality of electrical responses, each of the plurality of light signals each having a respective one of a plurality of center frequencies; and filtering the electrical response comprising: filtering each of the plurality of electrical responses to isolate a respective one of a plurality of beat-note signals having a respective amplitude that is inversely related to the concentration of the species, the plurality of interference signals, the plurality of light signals, and the plurality of beat-note signals including the interference signals, the light signal, and the beat-note signal, respectively.

(C8) Any one of embodiments (C1)-(C8) further including the method includes determining, from the plurality of beat-note signals, an absorption spectrum spanning the plurality of center frequencies; and determining an altitude of the gaseous plume by at least one of (i) fitting pressure-dependent lineshape functions to the absorption spectrum and (ii) comparing the absorption spectrum to a plurality of reference absorbance spectra of the species at a respective one of plurality of atmospheric pressures.

(C9) Any one of embodiments (C1)-(C9) further including the method includes determining a location of the gaseous plume from the altitude, an elevation angle of a source of the solar signal, and a direction of the source relative to a device that detects the interference signal.

(C10) Any one of embodiments (C1)-(C10) further including the method includes generating a three-dimensional tomographic dataset of a plurality of gaseous plumes by, for each of the plurality of gaseous plumes: determining a respective location of the gaseous plume by executing the method of embodiment (C9).

(C11) Any one of embodiments (C1)-(C11) further including the method includes measuring wind velocity; and determining the location comprising determining a location from the altitude, the elevation angle, and the direction.

(D1) A photonic integrated circuit for gaseous leak detection includes: a multimode interference coupler having a first input port, a second input port, and an output port; a first grating coupler, coupled to the first input port, that couples a solar signal into the multimode interference coupler; a second grating coupler, coupled the second input port, that couples a light signal into the multimode interference coupler; an output grating coupler coupled to the output port, which outputs an interference signal; and a detector, coupled to the output grating coupler, that generates an electrical response to detection of the interference signal.

(D2) The embodiment (D1) further including a transimpedance amplifier that amplifies the electrical response.

(D3) Either one of embodiments (D1) or (D2) further including a signal filter that filters the electrical response to isolate a beat-note signal inversely related to a species concentration of a gaseous plume located along a path of the solar signal; a local oscillator that generates the light signal having a light-signal frequency associated with methane absorption; and a signal detector that records the beat-note signal.

(D4) Any one of embodiments (D1)-(D4) further including a lineshape discriminator communicatively coupled to the signal detector to determine altitude of a gaseous plume corresponding to the species concentration.

(D5) Any one of embodiments (D1)-(D5) further including a RF amplifier that amplifies the beat-note signal to generate an amplified beat-note signal.

Changes may be made in the above gas leak detection methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present gas leak detection method and system, which, as a matter of language, might be said to fall therebetween.

1. A gas leak detector, comprising:
a solar detector that generates an electrical response by interfering a light signal with a solar signal and detecting a resultant interference signal; and
a signal filter, communicatively coupled to the solar detector, that filters the electrical response to isolate a beat-note signal having an amplitude that is inversely related to a concentration of a species that forms a gaseous plume located along a path of the solar signal.

2. The detector of claim 1, further comprising a local oscillator that generates the light signal, the light signal having a light-signal frequency corresponding to a resonance absorption of the species.

3. The detector of claim 2, further comprising a controller communicatively coupled to the local oscillator that sets the light-signal frequency based at least in part on at least one of: intensity of the solar signal and target-species concentration.

4. The detector of claim 2, the local oscillator further comprising:
a light source; and
a laser driver that tunes a frequency of the light source such that (i) the local oscillator generates a plurality of light signals each having a respective one of a plurality of center frequencies, (ii) the solar detector generates a respective one of a plurality of electrical responses by mixing each of the plurality of light signals with the solar signal, and (iii) the signal filter filters each of the plurality of electrical responses to isolate a respective one of a plurality of beat-note signals, the plurality of light signals, the plurality of electrical responses, and the plurality of beat-note signals including the light signal, the electrical response, and the beat-note signal, respectively.

5. The detector of claim 4, further comprising:
a signal detector that records each of the plurality of beat-note signals; and
at least one hardware processor communicatively coupled to the signal detector; and
a memory storing a plurality of reference absorbance spectra of the species at a respective one of plurality of atmospheric pressures, and machine readable instructions that when executed by the at least one hardware processor, cause the at least one hardware processor to:
determine, from the plurality of beat-note signals, an absorption spectrum spanning the plurality of center frequencies, and
determine an altitude of the gaseous plume by at least one of (i) fitting pressure-dependent lineshape functions to the absorption spectrum and (ii) comparing the absorption spectrum to a plurality of reference absorbance spectra of the species at a respective one of plurality of atmospheric pressures.

6. A gas leak detector comprising:
an array of gas leak detectors of claim 4, each of which generating a respective plurality of beat-note signals associated with a respective one of a plurality of gaseous plumes that includes the gaseous plume;
a signal detector that records each of the respective pluralities of beat-note signals; and
at least one hardware processor communicatively coupled to the signal detector;
a memory storing machine readable instructions that when executed by the at least one hardware processor, cause the at least one hardware processor to generate a three-dimensional tomographic dataset of the plurality of gaseous plumes, for each of the plurality of gaseous plumes, by:
determining, from the plurality of beat-note signals, an absorption spectrum spanning the plurality of center frequencies; and
determining an altitude of the gaseous plume by at least one of (i) fitting pressure-dependent lineshape functions to the absorption spectrum and (ii) comparing the absorption spectrum to a plurality of reference absorbance spectra of the species at a respective one of plurality of atmospheric pressures.

7. The detector of claim 1, further comprising a signal detector communicatively coupled to the signal filter, that records the beat-note signal.

8. The detector of claim 1, further comprising a photonic integrated circuit that includes the solar detector and signal filter.

9. The detector of claim 1, further comprising an anemometer that assists in locating methane leak location.

10. A method for detecting a gas leak, comprising:
detecting an interference signal produced from interference of a solar signal with a light signal to generate an electrical response; and
filtering the electrical response to isolate a beat-note signal having an amplitude that is inversely related to a concentration of a species that forms a gaseous plume located along a path of the solar signal.

11. The method of claim 10, further comprising generating, with a local oscillator, the light signal having a light-signal frequency associated with species absorption.

12. The method of claim 11, further comprising selecting the light-signal frequency based at least in part on one or more or more of (a) intensity of the solar signal and (b) the concentration of the species.

13. The method of claim 10, further comprising determining location of a gaseous plume corresponding to the concentration of the species, based at least in part on atmospheric pressure.

14. The method of claim 10, further comprising detecting, with a plurality of subdetectors each communicatively coupled to one of a plurality of sub-filters, a corresponding portion of the electrical response isolated by a corresponding sub-filter.

15. The method of claim 10, further comprising amplitude modulating the light signal.

16. The method of claim 10, further comprising:
detecting a plurality of interference signals produced from interference of the solar signal with a plurality of light signals to generate a plurality of electrical responses, each of the plurality of light signals having a respective one of a plurality of center frequencies; and
filtering each of the plurality of electrical responses to isolate a respective one of a plurality of beat-note signals having a respective amplitude that is inversely related to the concentration of the species, the plurality of interference signals, the plurality of light signals, and the plurality of beat-note signals comprising the interference signals, the light signal, and the beat-note signal, respectively.

17. The method of claim 16, further comprising:
determining, from the plurality of beat-note signals, an absorption spectrum spanning the plurality of center frequencies; and
determining an altitude of the gaseous plume by at least one of (i) fitting pressure-dependent lineshape functions to the absorption spectrum and (ii) comparing the absorption spectrum to a plurality of reference absorbance spectra of the species at a respective one of plurality of atmospheric pressures.

18. The method of claim 17, further comprising:
determining a location of the gaseous plume from the altitude, an elevation angle of a source of the solar signal, and a direction of the source relative to a device that detects the interference signal.

19. The method of claim 18, wherein:
the gaseous plume is one of a plurality of gaseous plumes; and
the method further comprises generating a three-dimensional tomographic dataset of a plurality of gaseous plumes, for each of the plurality of gaseous plumes, using the location as determined for each of the plurality of gaseous plumes.

20. The method of claim 18, further comprising:
measuring wind velocity; and
determining the location comprises determining a location from the altitude, the elevation angle, the direction, and the wind velocity.

21-25. (canceled)
